(19) United States
(12) Patent Application Publication
(10) Pub. No.: US 2019/0239690 A1
(43) Pub. Date: Aug. 8, 2019

(54) INTELLIGENT COOKING MACHINE

(71) Applicants: Yiming Ma, Guangzhou (CN); Shuxiong Yan, Brooklyn, NY (US)

(72) Inventors: Yiming Ma, Guangzhou (CN); Shuxiong Yan, Brooklyn, NY (US)

(21) Appl. No.: 15/906,042

(22) Filed: Feb. 27, 2018

(30) Foreign Application Priority Data
Feb. 7, 2018 (CN) 201820216077.6

(51) Int. Cl. A47J 37/12; A47J 36/00

(52) U.S. Cl. CPC A47J 37/1228; A47J 37/1276; A47J 36/00

(57) ABSTRACT

A smart cooking machine comprises a machine body, which comprises a cooking apparatus and an upper cover apparatus positioned right above the cooking apparatus and comprising a lower hopper, a connecting box, a sliding mechanism, and an underplate equipped with a window right above the pot body of the cooking apparatus. The sliding mechanism is positioned above the window. The connecting box is fixedly connected to the underplate and of a hollow structure in which the lower hopper is placed, with the discharge hole of the lower hopper being located right above the window on the underplate, and the sliding mechanism slides on the underplate to uncover or cover the window and is connected to the main controller through electrical connection. This machine is highly automated and simple in structure.

### BACKGROUND OF THE INVENTION

### 1. Field of the Invention

The present invention relates to the field of kitchen appliance technologies, particularly to an intelligent cooking machine that can cook automatically.

### 2. Description of the Related Art

To turn raw food into today's delicacies, human beings have undergone thousands of years of evolutions and inheritance. For example, Chinese food enjoys a worldwide reputation and is liked by many people. However, it is not easy to cook it well. The cooking process is complicated, and the taste of a dish varies wildly from one person to another due to differences in cooking habits. Chinese cooking skill seems to be unfathomable. However, no matter how complicated it is, it can be summarized into three key elements: 1. ratio of main ingredients to minor ingredients and proper use of various condiments, 2. heat control at different stages, and 3. reasonable time control. The great differences in dishes and nutrients arise from the different combinations of the three cooking elements.

People have long been yearning for a way to make complicated traditional cooking methods easier to learn and more efficient, which is coming true gradually with the flourish and development of the Internet and computer technologies. Currently, in China, many kitchen automation products, such as automatic household cooking machines and cooking robots, have come on the market. However, kitchen automation is still at the early stage right now. Many product technologies have not been mature, and the solutions having been implemented suffer from drawbacks. Most of the products are semi-automatic, have complicated structures, large sizes, and incomprehensive functions, and are only able to stir-fry food simply.

### SUMMARY OF THE INVENTION

An object of the invention is to provide a versatile smart cooking machine which can stir-fry, deep-fry, braise, stew, and otherwise cook food automatically. It can turn over food with the turner, inject cooking oil, control cooking temperature and time, add ingredients, sauce, and condiments, pour out food, wash pot, pour water, and so on automatically, featuring a high automation degree.

To achieve the object of the present invention, the present invention discloses a smart cooking machine comprising a machine body wherein the machine body comprises a cooking apparatus and an upper cover apparatus positioned right above the cooking apparatus and comprising a lower hopper, a connecting box, a sliding mechanism, and an underplate equipped with a window right above the pot body of the cooking apparatus; the sliding mechanism is positioned above the window, the connecting box is fixedly connected to the underplate and of a hollow structure in which the lower hopper is placed, with the discharge hole of the lower hopper being located right above the window on the underplate, and the sliding mechanism slides on the underplate to uncover or cover the window and is connected to the main controller through electrical connection.

Furthermore, the cooking apparatus also preferably comprises a connection frame wherein the pot body is placed and fixed on the inside and the connection frame is connected to a first rotating apparatus connected through electrical connection to the main controller driving the first rotating apparatus to control the rotation of the connection frame and the pot body.

The first rotating apparatus may comprise a first transmission shaft, a first bearing, a first bearing seat, and a first drive motor wherein the first drive motor is connected to the main controller through electrical connection and connected to the first transmission shaft housed with the first bearing positioned on the first bearing seat, the first transmission shaft is fixed to the connection frame, and the first drive motor controls the rotation of the first transmission shaft driving the rotation of the connection frame and the pot body.

The cooking apparatus may be also equipped with a turner apparatus comprising a turner body and a turner driving apparatus wherein the turner driving apparatus comprises a second transmission shaft, a second bearing, a second bearing seat, and a second drive motor wherein the second drive motor is connected to the main controller through electrical connection and connected to the second transmission shaft housed with the second bearing positioned on the second bearing seat fixed to the connection frame, the second transmission shaft stretches into the pot body after passing through the connection frame and the through-hole on the pot body, the turner body is fixed to the second transmission shaft stretching into the pot body, and the second drive motor drives the second transmission shaft to move and drive the turner body to move.

The cooking apparatus may be also equipped with a sauce conveying apparatus comprising a sauce container, a switch assembly, and a hose, wherein the switch assembly is connected to the main controller through electrical connection and connected to the sauce container, one end of the hose is connected to the sauce container, and the other end stretches into the pot body via the through-hole on the pot body to add sauce.

The first transmission shaft may be of a hollow structure in which the hose is placed and stretches into the pot body via the through-hole on the pot body to add sauce.

The underplate may be provided with a first discharge hole and a second discharge hole wherein the first discharge hole is connected to a tap-water pipe via the hose and the second discharge hole is connected to the oil bottle via the hose.

The cooking apparatus may be also equipped with a food container and water catcher positioned on both sides of the pot body rotating toward one side driven by the first rotating apparatus and rotating toward the other side when vegetables are poured on the food container, and after the pot washing water is poured into the water catcher, the water in the water catcher flows out of the smart cooking machine through the water pipe.

The turner body may comprise a slice, a turner frame, a first clamping plate, and a second clamping plate wherein the slice is placed between the first clamping plate and the second clamping plate, and the slice, the first clamping plate, and the second clamping plate are connected and fixed to the turner frame with nuts.

The machine body may be also equipped with a touch screen connected to the main controller through electrical connection.

Compared with the prior art, the present invention has the following advantages:

1) the smart cooking machine disclosed herein comprises a cooking apparatus and an upper cover apparatus positioned right above the cooking apparatus and comprising a lower hopper and a window above which a sliding mechanism is positioned to uncover or cover the window by sliding so that the cooking pan on the cooking apparatus can be sealed to provide frying, stir-frying, braising, and stewing functions;

2) with the first rotating apparatus, the pot body can rotate to pour out food and water automatically, and with the turner driving apparatus being set, stir-frying, pot washing, and other automatic actions, as well as automatic water injection and oil, cooking time and temperature control, ingredients addition, sauce and condiments injection, and other functions can be provided; and

3) the smart cooking machine of the present invention is highly automatic, versatile, and simple in structure.

4) sauce conveying apparatus is equipped to add sauce automatically; and

5) the pot body is connected to the connection frame with nuts, and all parts of the turner body are fixed with nuts, which can facilitate disassembly, replacement, cleaning, and maintenance.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

In the drawings:

FIG. 1 is a schematic diagram of the complete smart cooking machine of the present invention;

FIG. 2 is an explosive view of the smart cooking machine of the present invention;

FIG. 3 is an explosive view of the upper cover apparatus of the present invention;

FIG. 4 is an explosive view of the pot body and the connection frame of the present invention;

FIG. 5 is a cross-sectional view of the smart cooking machine of the present invention;

FIG. 6 is a schematic diagram of the connection frame herein turning to the position of pouring water;

FIG. 7 is a schematic diagram of the connection frame herein turning to the position of pouring food;

FIG. 8 is an explosive view of the turner body of the present invention;

FIG. 9 is a schematic diagram of the smart cooking machine herein with the sliding door being open.

### DETAILED DESCRIPTION OF THE PRESENTLY PREFERRED EMBODIMENTS

The foregoing object, features, and advantages herein will become clearer and more understandable upon reading the following detailed description of the present invention by referencing to the drawings and embodiments.

It can be understood by those skilled in the art that the terms “a”, “one”, and “said” herein do not exclude a plural number. Furthermore, it should be understood that the term “comprise” herein means the existence of the feature, integer, step, operation, element, and/or component but does not exclude the existence or addition of one or a plurality of other features, integers, steps, operations, elements, component, and/or their combinations. It should be understood that when an element is “connected” or “coupled” to another element herein, it may be connected or coupled to another element directly, or optionally, with an intermediate element. Furthermore, the “connected” or “coupled” herein may contain the wireless manner. The term “and/or” herein contains one listed item, all relevant items having been listed, any combination of such items, or all combinations of such items.

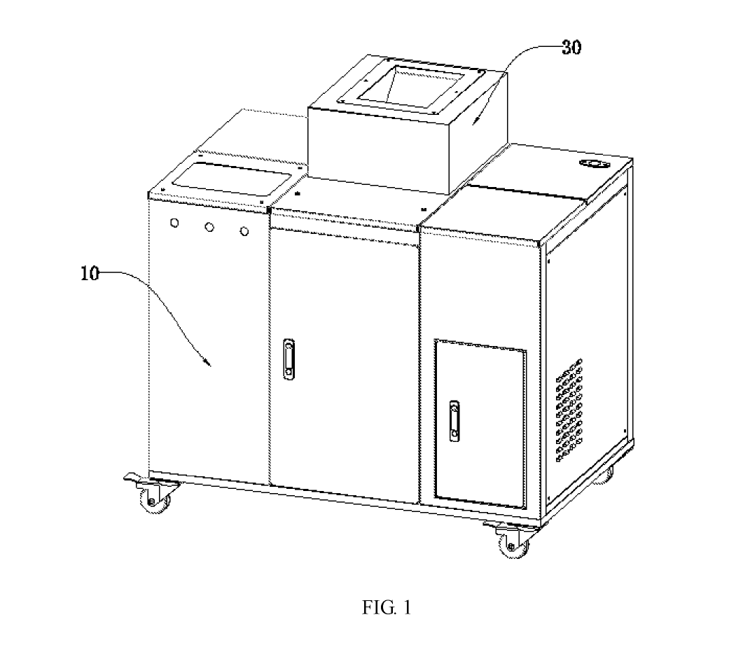

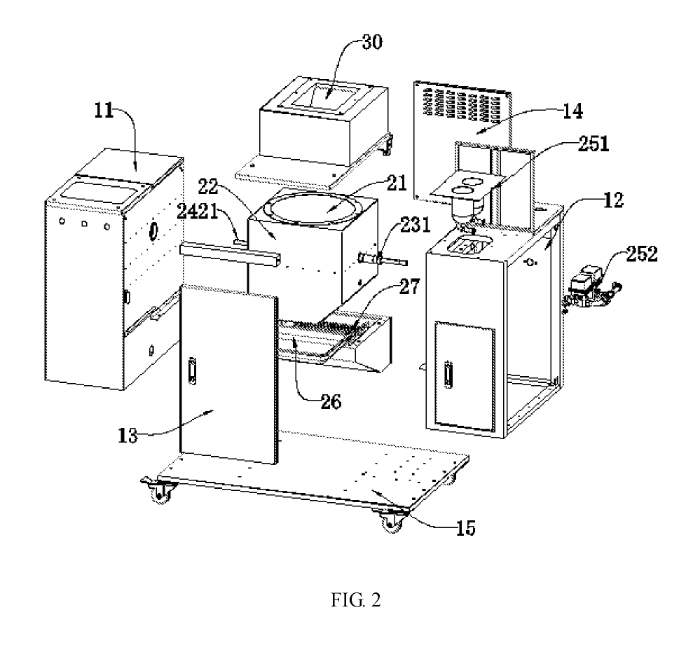

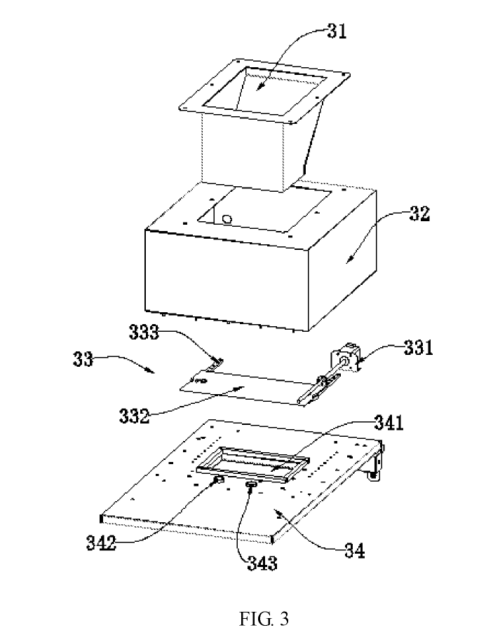

Referring to FIG. 1-FIG. 3, to achieve the aforementioned object, the present invention discloses a smart cooking machine comprising a machine body 1 wherein the machine body comprises a housing 10, a cooking apparatus 20, and an upper cover apparatus 30 positioned right above the cooking apparatus 20 and comprising a lower hopper 31, a connecting box 32, a sliding mechanism 33, and an underplate 34 equipped with a window right 341 right above the pot body of the cooking apparatus 20; the sliding mechanism 33 is positioned above the window 341, the connecting box 32 is fixedly connected to the underplate 34 and of a hollow structure in which the lower hopper 31 is placed, with the discharge hole of the lower hopper 31 being located right above the window 341 on the underplate 34, and the sliding mechanism 33 slides on the underplate 34 to uncover or cover the window 341 and is connected to the main controller (not shown in the drawings) through electrical connection. The sliding mechanism furthermore comprises a driving mechanism 331, a sliding door 332, and a guide rail 333 wherein the driving mechanism 331 is connected to the sliding door 332 driven by the driving mechanism 331 to slide along the guide rail 333 located on the side of the window 341, and thus the sliding door 332 can uncover or cover the window 341 by sliding on the guide rail 333. In this embodiment, when the sliding door 332 covers the window 341, the entire pot body 21 is sealed, and thus braising and stewing can be done in the pot body 21, and when the sliding door 332 uncovers the window 341, uncooked ingredients can be added to the pot body 21 through the lower hopper 31.

Furthermore, the underplate 34 is provided with a first discharge hole 342 and a second discharge hole 343 wherein the first discharge hole 342 and the second discharge hole 343 are aligned with the pot body 21, the first discharge hole 342 is connected to a tap-water pipe via a hose (not shown in the drawings) furthermore connected to a transmission pump to further add water and oil automatically and the transmission pump is connected to the main controller through electrical connection so that the main controller can add water and oil according to the recipe and the cooking time.

In this embodiment, the cooking apparatus 20 is of a sealed structure comprising a first supporting box 11, a second supporting box 12, a first baffle 13, a second baffle 14, and an underplate 15 wherein the first supporting box 11, the second supporting box 12, the first baffle 13, the second baffle 14, the underplate 15, and the upper cover apparatus 30 together form a sealed enclosure in which the cooking apparatus 20 is placed, and the first baffle 13 is of a structure that can be opened so that people can wash the pot body 21 and draw out the food container. The first supporting box 11 is equipped with a touch screen 111 connected to the main control module through electrical connection, and the touch screen 111 facilitates the user to perform human-computer interactions on the whole cooking machine, such as setting of temperature, selection of menu, selection of cooking way, and query of the current working status.

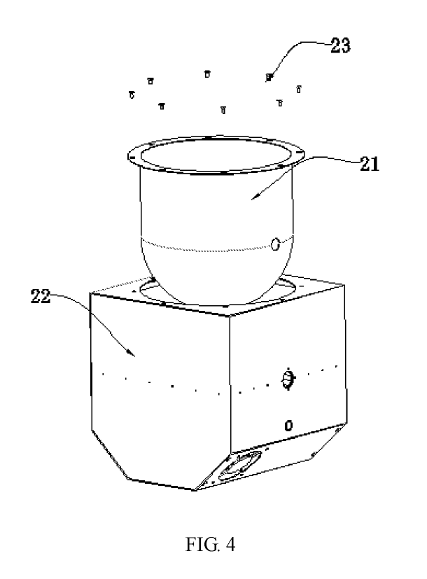

Referring to FIG. 4, in this embodiment, the cooking apparatus 20 also comprises a connection frame 22 in which the pot body 21 is positioned and fixed with nuts 23 to provide convenience for replacing the pot body 21 or drawing it out directly for washing. It saves efforts.

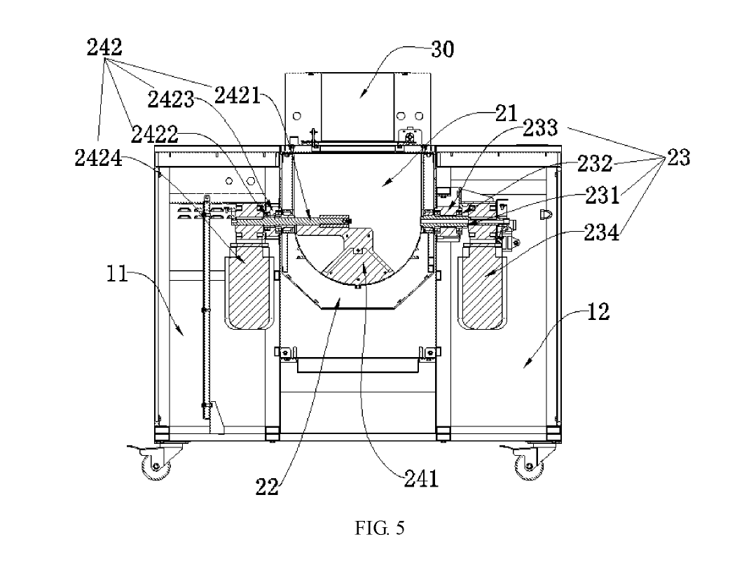

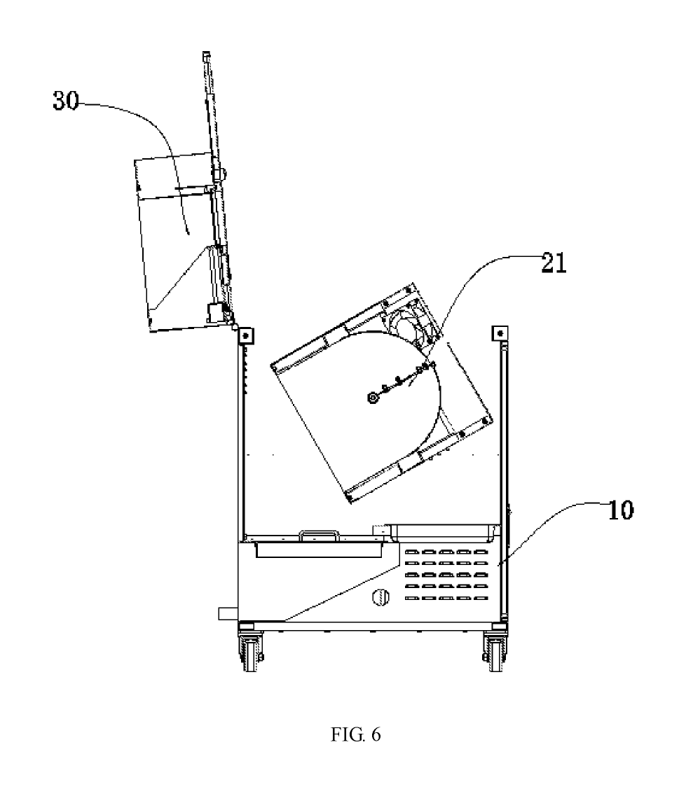

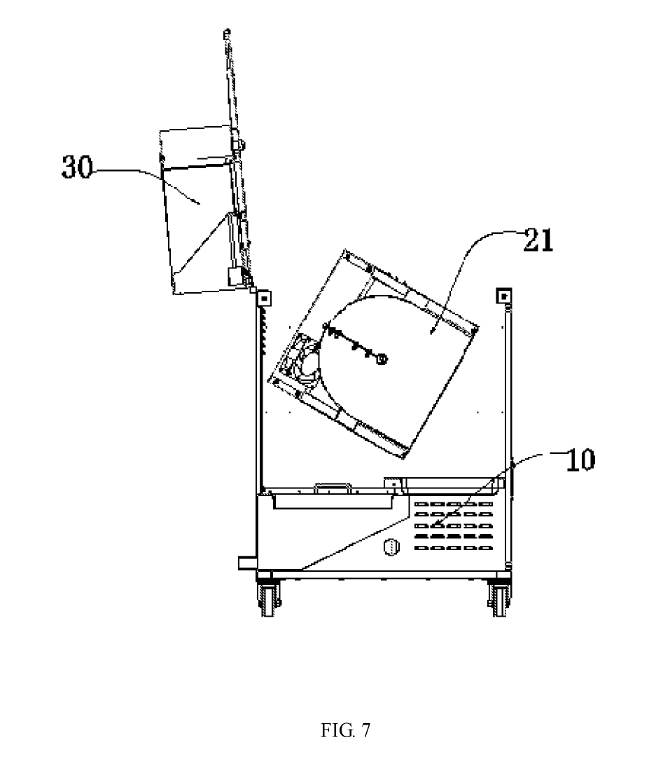

Furthermore, referring to FIG. 5, the connection frame 22 is connected to the first rotating apparatus 23 connected through electrical connection to the main controller driving the first rotating apparatus to control the rotation of the cooking apparatus. The first rotating apparatus 23 comprises a first transmission shaft 231, a first bearing 232, a first bearing seat 233, and a first drive motor 234 wherein the first drive motor 234 is connected to the main controller through electrical connection and connected to the first transmission shaft 231 housed with the first bearing 232 positioned on the first bearing seat 233, the first transmission shaft 231 is fixed to the connection frame 22, and the first drive motor 234 controls the rotation of the first transmission shaft 231 driving the rotation of the connection frame 22 and the pot body 21. In this embodiment, referring to FIG. 6-FIG. 7, the connection frame 22 has two rotation directions opposite to each other, and at the bottom of the connection frame 22 where both directions can be rotated toward, a food container 26 and water catcher 26 can be provided optionally. When the pot body 21 driven by the first rotating apparatus 23 rotates toward one side to a certain position, the food cooked is poured from the pot body 21 to the food container 26. After the food is poured out completely and the pot is washed, the washing water needs to be poured out, and at this moment, the main controller controls the first drive motor 234 by means of the first rotating apparatus 23, making the pot body 21 rotate toward the other side to pour the pot washing water into the water catcher 27. In this embodiment, the water in the water catcher 27 flows out of the smart cooking machine through the water pipe.

Furthermore, the cooking apparatus 20 is also equipped with a turner apparatus 24 comprising a turner body 241 and a turner driving apparatus 242 wherein the turner driving apparatus 242 comprises a second transmission shaft 2421, a second bearing 2422, a second bearing seat 2423, and a second drive motor 2424 wherein the second drive motor 2424 is connected to the main controller through electrical connection and connected to the second transmission shaft 2421 housed with the second bearing 2422 positioned on the second bearing seat 2423 fixed to the connection frame 22, the second transmission shaft 2421 stretches into the pot body 21 after passing through the connection frame 22 and the through-hole on the pot body 21, the turner body 241 is fixed to the second transmission shaft 2421 stretching into the pot body, and the second drive motor 2424 drives the second transmission shaft 2421 to move and drive the turner body 241 to move. In this embodiment, the second transmission shaft 2421 can rotate, stretch out and draw back by being driven by the second drive motor 2424, so as to drive the turner body 241 to fully stir-fry food or wash the inner wall of the pot body 21.

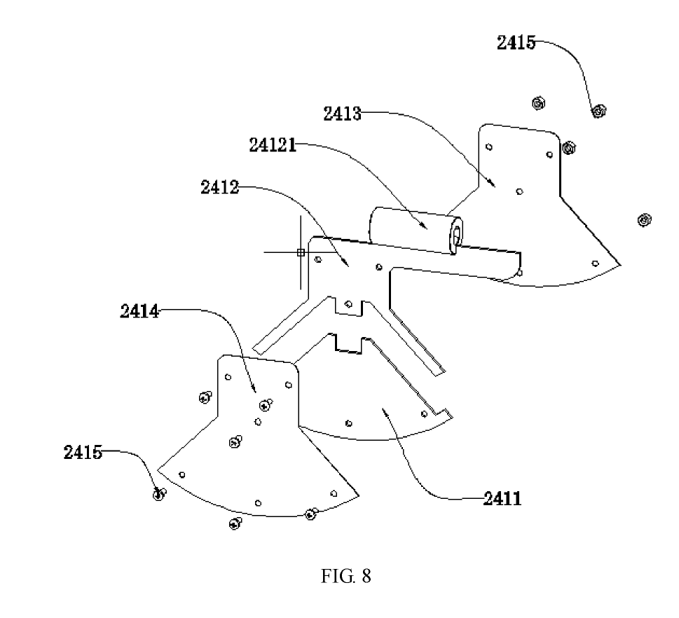

Referring to FIG. 8, in this embodiment, the turner body 241 comprises a slice 2411, a turner frame 2412, a first clamping plate 2413, and a second clamping plate 2414 wherein the slice 2411 is placed between the first clamping plate 2413 and the second clamping plate 2414, and the slice 2411, the first clamping plate 2413, and the second clamping plate 2414 are connected and fixed to the turner frame 2412 with nuts 2415. Above the turner frame, a holding position 24121 is provided for holding the second transmission shaft 2421 inserted into the holding position 24121 in a screwing manner, so that the second transmission shaft 2421 can be fixed. When the entire turner body 241 needs to be replaced, it can be done by just rotating the turner body 241 and then the turner body 241 can be departed from the second transmission shaft 2421. In this embodiment, the slice 2411 is made of silica gel, with heat-resistant food-grade flexible silica gel material being preferred. When the turner 241 is stir-frying food and washing the pot body 21, only the slice 2411 touches the inside of the pot body 21 and the slice 2411 will not scrape the inside of the pot body 21 so that the pot body 21 can be protected very well. However, both sides of the slice 2411 are supported by the first clamping plate 2413, the second clamping plate 2414, and the turner frame 2412, and thus, the slice 2411 can receive force very well and in the meanwhile, when washing the pot body 21 it can work as a scraper effectively to clean the dirt on the inner wall of the pot body 21 conveniently because of the friction. In this embodiment, screw 2415 is used to fix the turner 2411, which also facilitates the disassembly and replacement.

In this embodiment, the second supporting box 12 can also be equipped with a sauce conveying apparatus 25 comprising a sauce container 251, a switch assembly 252, and a hose (not shown in the figure), wherein the switch assembly 252 is connected to the main controller through electrical connection and connected to the sauce container 251, one end of the hose is connected to the sauce container 251, and the other end stretches into the pot body via the through-hole on the pot body 21 to add sauce. Furthermore, in this embodiment, the first transmission shaft 231 is of a hollow structure in which the hose is placed and stretches into the pot body 21 via the through-hole on the pot body 21 to add sauce.

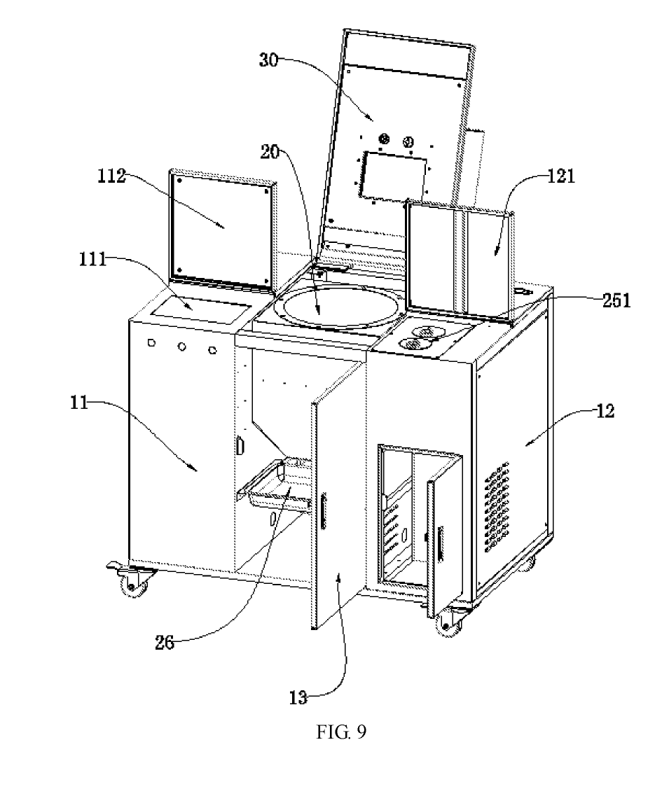

Furthermore, referring to FIG. 9, the first supporting box 11 is equipped with a first sliding door 112, and the touch screen 111 is uncovered when the first sliding door 112 is opened. And the second supporting box 12 is equipped with a second sliding door 121, and when the second sliding door 121 is opened the sauce container 251 is uncovered to add sauce or be drawn out for washing. When the sauce container 251 is being used, the second sliding door 121 should be closed to avoid the entry of any foreign matters into the sauce container 251. In this embodiment, one end of the upper cover apparatus 30 is hinged with the connection frame 22 and the other end is opened through rotation with the hinge as the axis to uncover the pot body 21 for washing or replacing cooking apparatuses such as the pot body 21.

The invention is not limited by the embodiments described above which are presented as examples only but can be modified in various ways within the scope of protection defined by the appended patent claims.

What is claimed is:

1. A smart cooking machine wherein the smart cooking machine comprises a machine body comprising a cooking apparatus and an upper cover apparatus positioned right above the cooking apparatus and comprising a lower hopper, a connecting box, a sliding mechanism, and an underplate equipped with a window right above the pot body of the cooking apparatus; the sliding mechanism is positioned above the window, the connecting box is fixedly connected to the underplate and of a hollow structure in which the lower hopper is placed, with the outlet of the lower hopper being located right above the window on the underplate, and the sliding mechanism slides on the underplate to uncover or cover the window and is connected to the main controller through electrical connection.

2. A smart cooking machine according to claim 1 wherein the cooking apparatus also comprises a connection frame wherein the pot body is fixed on the inside and the connection frame is connected to a first rotating apparatus connected through electrical connection to the main controller driving the first rotating apparatus to control the rotation of the connection frame and the pot body.

3. A smart cooking machine according to claim 2 wherein the first rotating apparatus comprises a first transmission shaft, a first bearing, a first bearing seat, and a first drive motor wherein the first drive motor is connected to the main controller through electrical connection and connected to the first transmission shaft housed with the first bearing positioned on the first bearing seat, the first transmission shaft is fixed to the connection frame, and the first drive motor controls the rotation of the first transmission shaft driving the rotation of the connection frame and the pot body.

4. A smart cooking machine according to claim 2 wherein the cooking apparatus is also equipped with a turner apparatus comprising a turner body and a turner driving apparatus wherein the turner driving apparatus comprises a second transmission shaft, a second bearing, a second bearing seat, and a second drive motor wherein the second drive motor is connected to the main controller through electrical connection and connected to the second transmission shaft housed with the second bearing positioned on the second bearing seat fixed to the connection frame, the second transmission shaft stretches into the pot body after passing through the connection frame and the through-hole on the pot body, the turner body is fixed to the second transmission shaft stretching into the pot body, and the second drive motor drives the second transmission shaft to move and drive the turner body to move.

5. A smart cooking machine according to claim 3 wherein the cooking apparatus is also equipped with a sauce conveying apparatus comprising a sauce container, a switch assembly, and a hose, wherein the switch assembly is connected to the main controller through electrical connection and connected to the sauce container, one end of the hose is connected to the sauce container, and the other end stretches into the pot body via the through-hole on the pot body to add sauce.

6. A smart cooking machine according to claim 5 wherein the first transmission shaft is of a hollow structure in which the hose is placed and stretches into the pot body via the through-hole on the pot body to add sauce.

7. A smart cooking machine according to claim 1 wherein the underplate is provided with a first discharge hole and a second discharge hole wherein the first discharge hole is connected to a tap-water pipe via the hose and the second discharge hole is connected to the oil bottle via the hose.

8. A smart cooking machine according to claim 2 wherein the cooking apparatus is also equipped with a food container and water catcher positioned on both sides of the pot body rotating toward one side driven by the first rotating apparatus and rotating toward the other side when vegetables are poured on the food container, and after the pot washing water is poured into the water catcher, the water in the water catcher flows out of the smart cooking machine through the water pipe.

9. A smart cooking machine according to claim 4 wherein the turner body comprises a slice, a turner frame, a first clamping plate, and a second clamping plate wherein the slice is placed between the first clamping plate and the second clamping plate, and the slice, the first clamping plate, and the second clamping plate are connected and fixed to the turner frame with nuts.

10. A smart cooking machine according to claim 1 wherein the machine body is also equipped with a touch screen connected to the main controller through electrical connection.
